(19) United States
(12) Patent Application Publication
(10) Pub. No.: US 2017/0001613 A1
(43) Pub. Date: Jan. 5, 2017

(54) MOTOR VEHICLE

(71) Applicant: AUDI AG, 85045 Ingolstadt (DE)

(72) Inventors: MARTIN STEMMER, Niiderding (DE); TOBIAS BROK, Kösching (DE)

(73) Assignee: AUDI AG, 85045 Ingolstadt (DE)

(21) Appl. No.: 15/106,640

(22) PCT Filed: Nov. 3, 2014
(86) PCT No.: PCT/EP2014/002942

§ 371 Date: Jun. 20, 2016

(30) Foreign Application Priority Data
Dec. 21, 2013 (DE) 102013021871.3

(51) Int. Cl. B60T 8/94; B60T 13/14; B60T 13/68; B60T 8/88; B60T 17/22

(52) U.S. Cl. CPC B60T 8/94; B60T 8/885; B60T 17/22; B60T 13/686; B60T 13/14; B60T 2270/402

(57) ABSTRACT

A motor vehicle includes a plurality of wheels and a brake system, which has brakes, which can be hydraulically actuated and are each associated with a wheel. The brakes can be actuated by at least one brake circuit which can be operated by a brake booster. The brake booster can be actuated by a brake pedal to be pressed by the driver. At least one pressure-generating and/or pressure-accumulating device, controlled by a control device to modulate the hydraulic pressure within the brake circuit. A second pressure-generating and/or pressure-accumulating device is provided in the brake circuit to automatically increase the pressure within the brake circuit in dependence on demand independently of the first pressure-generating and/or pressure-accumulating device, when a malfunction is detected in the brake system.

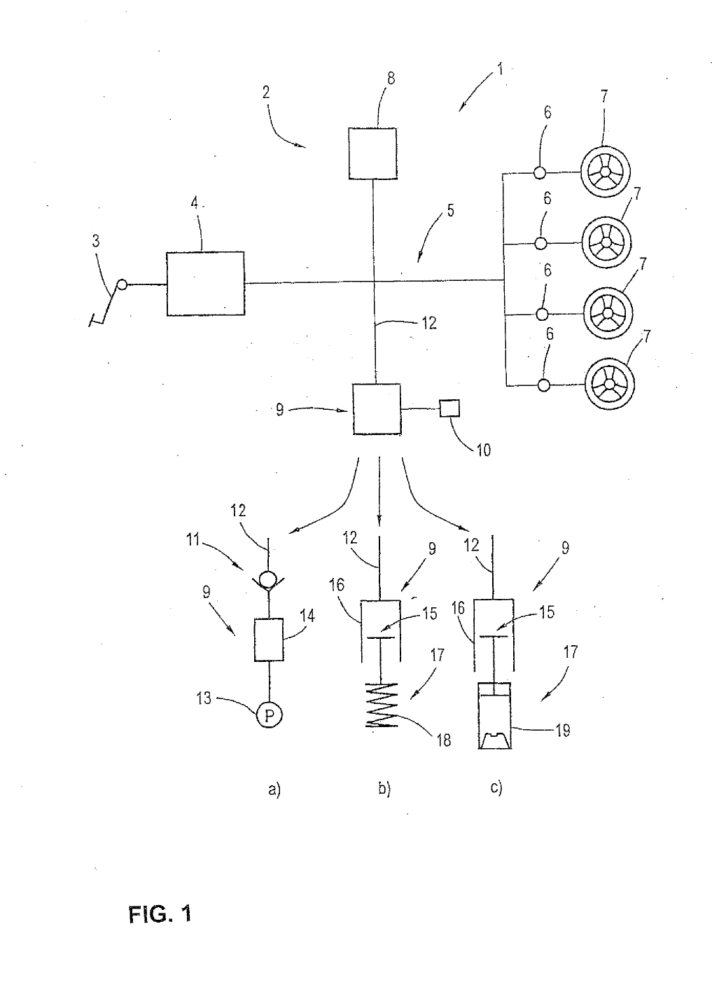

The invention relates to a motor vehicle including a plurality of wheels and a braking system having hydraulically actuated brakes associated with the wheels, respectively, at least one brake circuit via which the brakes are actuated, a brake booster via which the brake circuit can be operated, wherein the brake booster can be actuated via a brake pedal actuated by the driver, and at least one pressure generating and/or pressure storage device which is controllable via a control device and via which the hydraulic pressure can be modulated within the braking circuit.

Motor vehicles generally have disk brakes assigned to the respective wheels, wherein drum brakes are sometimes also installed. The brakes are actuated via a hydraulic brake circuit which, in turn, is operated via a brake booster in order to generate the necessary hydraulic pressure. A brake booster is hereby to be understood as including brake pressure generating devices without and with modulation devices, which are used for the provision of ABS and ESC functions. The brake booster, in turn, is coupled in known motor vehicles to the brake pedal, wherein the brake pedal typically is part of a foot lever system on which at least an accelerator pedal or, where applicable, a clutch pedal is provided.

Such known braking systems are nowadays designed fail-safe. This means that when a fault occurs in the braking system itself or in a system component such as, for example, corresponding actuating elements, within the communications link to control devices etc., or the energy supply, the braking system is ultimately deactivated. In this context, braking system is understood to be the brake booster and the brake control, usually with the main functions of ABS (anti-lock braking system) and ESC (electronic stability control). This means that these functions are no longer available, sometimes also the brake booster no longer operates normally. The driver thereby serves as a fallback. In case of failure, he assumes the task of braking the motor vehicle by increased force which he introduces via the brake pedal, consequently to build up the required brake pressure. The driver has to stabilize the motor vehicle himself and select a suitable travel mode in order to control and brake it in case of a failure. This means that the driver is included as a fallback in the security concept.

Modern motor vehicles already allow partially autonomous driving, thus driving in which the driver is at least in part no longer involved in the motor vehicle guidance. Development increasingly is aimed in a direction of relieving the driver as much as possible towards piloted, respectively predominantly autonomous driving. That means that the vehicle including the respective control is automatically capable to guide the motor vehicle longitudinally and transversely without the need for involving the driver. He can attend to other things. With increasing scope of piloted driving, the demands on safety-relevant motor vehicle systems however also increase, which then need no longer be configured “fail-safe”, but “fail-operational”, because they must be able to guide the motor vehicle autonomously, even in the case of a fault, for at least a certain bridging period, that is until the driver himself is actively involved in the driving operation again. This means that the “fail-operational” control must be configured such as if the driver was still actively involved in its entirety. Currently known braking system architectures however, do not allow the realization of such a “fail-operational” behavior since they are still geared to the driver as a fallback.

The invention is thus based on the problem to provide a motor vehicle which allows a “fail-operational” mode with simply conceived configuration of the braking system.

To solve this problem, provision is made according to the invention in a motor vehicle of the aforementioned type for a second pressure generating and/or pressure storage device in the brake circuit, via which, depending on demand, the pressure within the brake circuit can be automatically increased independently on the first pressure generating and/or pressure storage device in the case of malfunction detected in the braking system.

A second, separately controllable pressure generating and/or pressure storage device is provided in the motor vehicle according to the invention and serves to generate the required hydraulic pressure for the automatic selective braking of the vehicle in the presence of any type of error in the brake system resulting in a partial of complete malfunction so that the braking system including its integrated components, in particular those that are responsible for ABS and ESC functionalities, no longer correctly fulfill the required function. This second pressure generating and/or pressure storage device thus assumes as a fallback the function which previously had been the assigned to the driver in the “fail-safe” configured braking system. The driver is no longer involved in the case of the “fail-operational” configuration according to the invention. Rather, this second pressure generating and/or pressure storage device is used to generate the required hydraulic pressure depending on demand upon detection of a malfunction. This hydraulic pressure leads to the brakes being controllable via the brake circuit, in order to decelerate the vehicle accordingly. This is executed at least until the driver can be actively involved again. Detection of a possible malfunction within the braking system is, of course, realized via a corresponding sensor including independent functional tests of the integrated components, for example the ESC unit, which normally includes a corresponding valve assembly with associated control device, with the valve assembly in turn including its own hydraulic pump etc. Also communication errors of components integrated within the braking system, communicating with each other and to be controlled or controlling, can be detected and used as a basis for controlling the second pressure generating and/or pressure storage device. Also, a possible power failure which affects the operation of an integrated component can represent such a malfunction.

Since the second pressure generating and/or pressure storage device only serves to generate a sufficiently high brake or hydraulic pressure for a short time in an emergency as a fallback, it can be configured much more simply than the described first pressure generating and/or pressure storage device, which, for example, may involve a ESC block used for the modulation of the braking pressure in the braking system, via which thus the individual brake pressures to the separate brakes can be varied individually to decelerate the vehicle in a targeted manner. This first pressure generating and/or pressure storage device has, as configured, a corresponding valve assembly with a plurality of separately controllable, correspondingly connected valves, one or more associated pumping devices for generating a corresponding hydraulic pressure, and a separate control device. The second pressure generating and/or pressure storage device is not to be designed as complex, as it merely serves for the temporary and need-dependent increase in hydraulic pressure without modulation function, etc. Different configurations of such a second pressure generating and/or pressure storage device are conceivable in this context.

According to a first alternative according to the invention, the second pressure generating and/or pressure storage device can be coupled via a switchable valve to the brake circuit and feed hydraulic fluid in the brake circuit under increased pressure as the valve is open. The second pressure generating and/or pressure storage device is thus switched in the brake circuit and can be hydraulically coupled to the brake circuit via a controllable valve. With the valve is open, appropriate hydraulic fluid can now be fed under high pressure into the brake circuit via the second pressure generating and/or pressure storage device, via which the pressure is increased in the braking circuit overall and the brakes are correspondingly actuated in order to decelerate the vehicle.

The second pressure generating and/or pressure storage device can hereby include a hydraulic pump to generate the required hydraulic pressure. But it is also conceivable to provide the pressure increase by using a hydraulic pump of the first pressure generating and/or pressure storage device, i.e. to couple the two devices to each other and to virtually continuously “charge” the second pressure generating and/or pressure storage device via the hydraulic pump of the first pressure generating and/or pressure storage device. Thus, when the valve opens, a “discharge process” is virtually established, thus respectively increasing the hydraulic pressure in the brake circuit. This only applies, for example, when the first pressure generating and/or pressure storage device has a malfunction, so that the pressure increase is no longer possible, which can, for example, be the case when the pump is defective, etc.

In an alternative embodiment to such a configuration of the second pressure generating and/or pressure storage device, provision is made to configure the latter as a mechanical device, including a piston movable via a switchable pressure generating element and acting on the hydraulic fluid upon release of the pressure generating element. This pressure generating member, preferably a releasably locked spring element, serves as an energy accumulator, which presses on the movable piston. When activation of the second pressure generating and/or pressure storage device is required in the event of a detected malfunction, the switchable pressure generating element is thus activated accordingly, i.e., for example, the spring element is released from its locking, so that forces are imposed upon the piston by the spring element and the required pressure builds up inside of the hydraulic system. The piston thus pushes the brake fluid into the circuit so that the brakes are actuated.

Since the activation of the second pressure generating and/or pressure storage device is always performed in the context of a type of emergency situation, i.e. in the presence of a correspondingly serious error, it is conceivable to return the pressure generating element to its initial position only during an upcoming maintenance that is required after a serious error occurs. Alternatively, it is conceivable to move the piston by an increase of the hydraulic pressure through operation of a hydraulic pump of the first pressure generating and/or pressure storage device against the recoiling force of the spring element until the spring element is locked again. That means, in the case that, for example, a fault occurred within the valve block in the first pressure generating and/or pressure storage device, but the hydraulic pump, still operates as before, the hydraulic pressure is increased again momentarily in order to push back the piston together with the spring element again by activating this hydraulic pump, after assuming a safe state decelerated to a standstill.

Another alternative to the afore-described mechanical configuration of the pressure generating element in the form of a spring element provides for the use of a pyrotechnic ignition device as a pressure generating element. This ignition device, which usually can be fired only once, also acts on the piston, which is correspondingly moved by the pressure built up during the ignition.

A further alternative embodiment provides for using as a second pressure generating and/or pressure storage device the brake booster itself, which is configured in this case as a vacuum brake power booster and can be ventilated via a switchable valve. In a braking system with vacuum brake booster, its storage effect can lead to autonomous braking through selective venting of the brake booster. One such selective ventilation can be achieved by a switchable valve.

Suitably, the second pressure generating and/or pressure storage device has its own separate control device, which preferable is always active via a correspondingly uninterruptible power supply. In particular, when the second pressure generating and/or pressure storage device has its own hydraulic pump for generating pressure, control of the system pressure can even also be established in case of failure of the pump of the first pressure generating and/or pressure storage device which is normally configured, as described, as an ESC block. In this case, this ESC block can not modulate the hydraulic pressure, but rather the pump of the second pressure generating and/or pressure storage device can operate the first device. Since, for example, the valve block can still be correspondingly switched in the ESC block, thus functions flawlessly, an ABS function can, for example, be at least rudimentarily reproduced. Even a complete ESC function would be conceivable.

Further advantages, features and details of the invention will become apparent from the exemplary embodiment described in the following and from the drawing.

The FIGURE shows in the form of a schematic representation a motor vehicle 1 according to the invention, wherein only the braking system 2 is shown here, including a brake pedal 3, which is usually actuated by the driver, a brake booster 4 that can be actuated via the brake pedal 3 and via which, in turn, a brake circuit 5 is operated, which, in turn, acts on individual brakes 6 which are associated with wheels 7, respectively. The FIGURE is a purely schematic representation. Of course, provision is normally made for two separate brake circuits, i.e. the braking system 2 is correspondingly configured as redundant. The FIGURE is purely a function diagram which should only represent the basic functionality of the invention.

Integrated into the braking system 2 is a first pressure generating and/or pressure storage device 8, for example, an ESC block, which includes in a manner known per se a corresponding valve block including a plurality of separately switchable valves, at least one hydraulic pump via which the pressure of the hydraulic fluid present in the brake circuit 5 can be varied, as well as a corresponding control device via which the individual valves as well as the hydraulic pump are controlled. The construction of such an ESC block is well known. The brake pressure within the braking system 2 can be modulated by it so that a respective individual pressure level can be applied to the respective brakes 6 in order to decelerate separately and selectively. Different assistance functions, such as, for example, an ABS function or a slip control etc. can be realized by its use.

According to the invention, a second pressure generating and/or pressure storage device 9 is now integrated into the braking system 2 and, if need be, is used to increase the brake pressure within the braking system 2 or the brake circuit 4, when a malfunction occurs in the braking system. Such a malfunction may, for example, involve a malfunction within the ESC block 8, for example, in the valve block, i.e. one or more valves can no longer be switched, causing a power failure and control of the ESC block 8 can no longer be realized, etc. In order to ensure “fail-operational” operation in this case, and to decelerate the motor vehicle without falling back on the driver, and to provide a sufficient transitional period to the driver, within which he may take over control again, the hydraulic pressure within the braking system 2 can temporarily be increased via this second pressure generating and/or pressure storage device 9, i.e. the brakes 6 are actuated to decelerate the motor vehicle in a targeted manner, i.e. initiate an automatic deceleration operation hereby. In the example shown, a separate control device 10 is assigned to the second pressure generating and/or pressure storage device 9 or the device 9 includes such, as an alternative a control could also be implemented via the control device of the ESC block, i.e. the first pressure generating and/or pressure storage device 8 as long as it is ensured that the latter is connected to an uninterruptible power supply and is active at all times.

When detecting any type of fault within the braking system 2, causing parts thereof or overall to no longer operate properly so that the driver is prompted to take over control of the motor vehicle, corresponding information is transmitted to the control device 10 which then commands an increase in pressure. It then comes to an automatic build-up of sufficiently high brake pressure in order to decelerate the vehicle. An action by the driver, as in only “fail-safe” configured systems in which the driver must actively actuate the accelerator pedal, for example, despite a malfunction within the brake booster 4, is not needed according to the present invention.

Different configurations of the second pressure generating and/or pressure storage device 9 are conceivable in order to be able to build up the increased brake pressure. These are shown in the FIGURE here merely by way of examples and alternatives represented with a), b) and c).

According to the embodiment a), the second pressure generating and/or pressure storage device 9 is integrated via a switchable valve 11 in a respective line 12, which is part of the braking system. It includes a separately controllable pump 13 via which the brake fluid residing in a reservoir 14 is pumped under high pressure. When the valve 11 is switched to open, the pump 13 is also automatically actuated so that hydraulic fluid is pumped under high pressure in the braking system 2 and the brakes 6 are correspondingly actuated. The corresponding activation of the controllable components is, of course, implemented via the control device 10.

Even though in accordance with configuration a) the pump 13 is part of the second pressure generating and/or pressure storage device 9, it is conceivable to use a corresponding pump, which is part of the first pressure generating and/or pressure storage device 8, instead of the pump 13. That means that, for example, during normal operation of this first pressure generating and/or pressure storage device 8, i.e. when the pump there thus operates flawlessly, the hydraulic fluid residing in the reservoir 14 is stored under high pressure at all times. If a fault is detected, there is only need to activate the valve 11 via the control device 10 so that the reservoir 14, thus the storage, is discharged.

In the embodiment according to the invention according to variant b), the second pressure generating and/or pressure storage device 9 includes a movable piston 15 in a cylinder 16, wherein piston 15 can be acted upon via a switchable pressure generating element 17. Hydraulic fluid which is received in the cylinder 16 is introduced via the line 12 under high pressure into the braking system 2 via the piston 15.

In the configuration according to b), the switchable pressure generating element 17 is a spring element 18 which is fixed in a locking position, in which it is compressed. When the switchable locking, which can be controlled via the control device 10, is released, the spring element 18 relaxes and actuates the piston 15, which then pushes the hydraulic fluid from the cylinder 16 under high pressure.

The embodiment variant c) is an alternative to variant b). Again, the second pressure generating and/or pressure storage device 9 includes a piston 15 which is movable in a cylinder 16. The switchable pressure generating element 17 is configured here as a pyrotechnic ignition device 19. When this is ignited, there is a sudden corresponding increase in pressure, which, in turn, acts on the piston 15, which is moved in the cylinder 16 and pushes the brake fluid into the braking system 2 under high pressure.

The exemplary embodiments shown in a), b) and c) merely represent examples. Of course, other embodiments may be selected as long as they realize a possible pressure increase in case of need.

Whereas the embodiment variants b) and c), since ultimately only able to be actuated once, allow a brief and ultimately not variable pressure increase, the embodiment variant a), depending on the encountered fault, even enables an at least rudimentary reproduction of the ABS or ESC functionalities realized during regular operation. In the event, for example, the pump is defective on the part of the ESC block 8 while the valve block is still fully operational, hydraulic fluid could thus be fed under respective pressure via the second pressure generating and/or pressure storage device 9 according to embodiment variant a) with its separate pump 13 and distributed respectively modulated via the valve block of the ESC block 8. The functionalities could be made available at least for a transitional period until either the driver has assumed full control, or until the vehicle is definitely braked to a standstill. Optionally, a possibly existing transmission is also automatically switched to the neutral level, as braking results in the standstill.

1.-9. (canceled)

10. A motor vehicle, comprising:
a plurality of wheels; and
a braking system including;
hydraulically actuatable brakes operably connected to the wheels in one-to-one correspondence,
at least one brake circuit configured for actuation of the brakes,
a brake booster operably connected to the brake circuit and actuated by a driver through actuation of a brake pedal,
a first member selected from the group consisting of a pressure generating device and a pressure storage device, said first member being configured for modulation of hydraulic pressure within the brake circuit,
a control device configured to control the first member, and
a second member selected from the group consisting of a pressure generating device and a pressure storage device and disposed in the brake circuit, said second member being configured to automatically increase pressure inside of the brake circuit independently of the first member, when a malfunction is detected in the brake system.

11. The motor vehicle of claim 10, further comprising a switchable valve, said second member being coupled to the brake circuit via the switchable valve and feeding hydraulic fluid under elevated pressure into the brake circuit with the switchable valve being open.

12. The motor vehicle of claim 10, wherein the second member includes a hydraulic pump, or is connected to a hydraulic pump of the first member.

13. The motor vehicle of claim 10, wherein the second member includes a mechanical device which includes a switchable pressure generating element, a piston movable by the pressure generating element and acting on the hydraulic fluid, when the pressure generating element is released.

14. The motor vehicle of claim 13, wherein the pressure generating element includes a releasably locked spring element.

15. The motor vehicle of claim 14, wherein the piston is movable in response to an increase of the hydraulic pressure through operation of a hydraulic pump of the first member in opposition to a recoiling force of the spring element until the spring element is locked again.

16. The motor vehicle of claim 13, wherein the pressure generating element includes a pyrotechnic ignition device.

17. The motor vehicle of claim 10, wherein the brake booster is configured as a vacuum brake booster and represents the second member, and further comprising a switchable valve configured for venting the vacuum brake booster.

18. The motor vehicle of claim 10, further comprising a further control device configured to control the second member.
